(19) United States
(12) Patent Application Publication
(10) Pub. No.: US 2026/0290177 A1
(43) Pub. Date: Sep. 24, 2026

(54) AUTOMATED FOLLOWING FLIGHT TO EXPLOIT UPDRAFT ZONES

(71) Applicant: Deutsches Zentrum für Luft- und Raumfahrt e.V., Bonn (DE)

(72) Inventors: Thomas STRANG, Wessling (DE); Leonardus JANSEN, JR., Wessling (DE)

(21) Appl. No.: 19/534,188

(22) Filed: Feb. 9, 2026

(30) Foreign Application Priority Data
Mar. 19, 2025 (DE) 10 2025 110 639.8

(51) Int. Cl. G08G 5/76; G08G 5/26

(52) U.S. Cl. CPC G08G 5/76; G08G 5/26

(57) ABSTRACT

A method and system for performing a following flight of a following aircraft in an updraft zone of a wake turbulence of a preceding aircraft, comprising sensor-supported detecting an airflow field with the following aircraft being in the updraft zone; determining a current position of the following aircraft relative to a vortex with the exploited updraft zone; and automatically adjusting the current position of the following aircraft to assume a predefined ideal position relative to the vortex with the exploited updraft zone by executing a flight control system, wherein an automatic response is executed by the following aircraft when at least one of the following is communicated via a communication link from the preceding aircraft: a modified flight control command on the preceding aircraft, an air traffic control instruction for the preceding aircraft, or a command to change a landing flap position or brake flap position on the preceding aircraft.

### CROSS-REFERENCE TO RELATED APPLICATIONS

This application claims benefit of German Patent Application No. 10 2025 110 639.8, filed on 19 Mar. 2025, the contents of which are incorporated herein by reference in their entirety.

### BACKGROUND

### Field

The invention relates to a method for performing a following flight of a following aircraft in an updraft zone of a wake turbulence of a preceding aircraft, and to a corresponding system.

### Related Art

When an aircraft with aerodynamic lift is in flight, wake turbulences are created behind the aircraft. These create a downdraft in the middle of the flight path behind the aircraft and an updraft on the outer edges. Such wake turbulences are described in more detail, for example, in the publication: Holzäpfel, F. (2014) Flugzeug-Wirbelschleppen—von der Grundlagenforschung zur Anwendung. promet, 39 (39), pp. 14-22. DWD. ISSN 0340-4552.

The updraft can be used by a following aircraft, with appropriate positioning relative to the preceding aircraft, to fly more efficiently and thus save fuel; see also the publication: Unterstrasser S, Stephan A. Far field wake turbulence evolution of two aircraft formation flight and implications on young contrails. The Aeronautical Journal. 2020;124(1275):667-702.doi:10.1017/aer.2020.3

The technical challenge in executing such a following flight lies particularly in the fact that the following aircraft must position itself quite precisely within an optimal region in order to optimally exploit the updrafts on the one hand, and on the other hand not to enter a zone of downdraft, as this would negate the energy yield and subject the wing to strong unsteady and high-frequency external aerodynamic forces and torques.

Such practical considerations make following flights interesting, although it is not currently implemented as a regular operating procedure in normal operations, as it contradicts current general aviation safety guidelines and procedures. However, it can be implemented, possibly to a limited extent, for special aviation missions with special authorizations and requirements for pilots and aircraft involved. The pilot of the following aircraft typically observes the location of the preceding aircraft (also called the “lead”) visually and thus estimates where the wake turbulence and therefore the optimal position of the following aircraft in relation to the preceding aircraft might be.

However, in so-called “clean air”, a pilot cannot see exactly where the wake turbulence is located at any given time, neither longitudinally nor laterally nor vertically, how intense a resulting force vector might be, and from this deduce where the optimal position is in an updraft field. While it is possible to generate a generic model of wake turbulences and their characteristic parameters (e.g., weight of the preceding aircraft, wingspan, speed, surrounding wind conditions, etc.), such a model is heavily heuristic and therefore not currently usable in practice, especially operationally in real time. Furthermore, there is no always legally and functionally safe method for how a following aircraft can approach and then separate from a preceding aircraft. Position corrections by the following aircraft, which are only carried out manually and based on the experience of its pilot, are naturally inaccurate.

### SUMMARY

The object of the invention is to make the following flight of a following aircraft in the updraft zone of a preceding aircraft, as described above, safer and easier.

The invention results from the features of the independent claims. Advantageous further developments and embodiments are the subject matter of the dependent claims.

A first aspect of the invention relates to a method for performing a following flight of a following aircraft in an updraft zone of a wake turbulence of a preceding aircraft, comprising the steps:
with the following aircraft in the updraft zone: sensor-based detecting an airflow field of the vortex with the exploited updraft zone;
based on the detected airflow field: determining a current position of the following aircraft relative to the vortex with the exploited updraft zone; and
automatically adjusting the current position of the following aircraft to assume a predefined ideal position relative to the vortex with the exploited updraft zone by executing a flight control system of the following aircraft, wherein an automatic response is executed by the following aircraft when, via a communication link from the preceding aircraft to the following aircraft, at least one of the following is communicated to the following aircraft: a modified flight control command on the preceding aircraft, an air traffic control instruction for the preceding aircraft, a command to change a landing flap position or airbrake position on the preceding aircraft, target parameters of the flight control system (e.g. nominal heading, nominal flight level, nominal airway).

The method is computer-implemented and therefore essentially automatic, wherein individual confirmations by a user, in particular a pilot, can be reasonably provided for and implemented. The preceding aircraft is, in particular, a fixed-wing aircraft the wings of which deflect the oncoming airflow and generate aerodynamic lift based on the conservation of momentum. A downdraft region of the preceding aircraft is accompanied by two individual vortices to the left and right of the centrally located downdraft region, with corresponding updraft regions being created at the edges of the vortices. The method is intended to simplify the process of using one of the two outer updraft regions for a following aircraft to harness their energy and achieve an energy-saving following flight.

To enable the exact positioning of the following aircraft in the updraft zone of the wake turbulence of the preceding aircraft, an automatic flight control system is used. This uses sensor data from a sensor unit located on the following aircraft, which detects an airflow field of the vortex into which the following aircraft is flying or has already flown, and determines a lateral and/or vertical position relative to this vortex. An ideal position correlates with a maximized use of the updraft zone while avoiding as much as possible the downdraft zone, even by the wingtip of the following aircraft, as otherwise highly unsteady aerodynamic influences on the affected wings are to be expected, resulting in medium-to low-frequency vibrations on the following aircraft, especially during roll motion.

For this purpose, a sensor unit on the following aircraft detects an airflow field in the direction of extension along a wing of the following aircraft; the individual sensor elements of the sensor unit are particularly preferably arranged distributed over both wings of the following aircraft if they are aerodynamic and/or aerostatic sensors. Additionally or alternatively, a lidar device can also be used on the following aircraft to measure the airflow field in an environment in front of the following aircraft by emitting laser light pulses. The structures of the vortices of wake turbulences are sufficiently known in the prior art, so that the data from the sensor unit can be compared with known information on these structures, and thus a sufficiently accurate current position of the following aircraft relative to the approaching vortex can be determined, at least in the transverse direction, and preferably also in a vertical direction.

This current position information is fed to an automatic flight control system of the following aircraft, so that it can strive for a predefined ideal position relative to the exploited vortex by correspondingly controlling flight control actuators and adjusting torque dynamics up to the engine power of the following aircraft. This ideal position is defined in particular by a vertical and lateral component, both of which are essentially perpendicular to a flight path direction of the preceding aircraft at the location of the exploited wake turbulence. In contrast, the longitudinal position and thus the distance to the preceding aircraft allows for significantly greater tolerances, since it only depends on a safety distance to the preceding aircraft as the lower limit of the longitudinal position, and on a still exploitable intensity of the updraft zone as the upper limit of the longitudinal position relative to the preceding aircraft, before the wake turbulence weakens too much due to friction effects.

It is an advantageous effect of the invention that, by using a sensor unit on the following aircraft, a relative position to an updraft zone of an exploited vortex of a wake turbulence of a preceding aircraft can be determined very precisely, and a predefined ideal position relative to the exploited vortex can be maintained very accurately fully automatically by using flight control. One possible application is in regular civil aviation, where significant amounts of kerosene and corresponding financial resources can be saved. Automatic corrections via flight control are thus possible even in highly dynamic situations, especially in the case of wind-induced shifts in the wake turbulence. However, it is also taken into account if a changed flight control command is made on the preceding aircraft, be it a manual flight control command or an automated flight control command, for example, by an autopilot. The flight control command includes, in particular, an input to change an attitude angle such as a pitch angle or a roll angle of the aircraft with the aim of changing another flight condition. A roll movement can be used to initiate a turn, or a pitch movement can initiate a new flight path angle relative to the earth to cause an altitude change in the aircraft. The modified flight control command may also include a thrust input for a changed thrust-to-drag ratio to increase or decrease speed or to increase or decrease the aircraft angle of climb relative to the ground. An air traffic control instruction, as a precursor to such a changed flight control command, can also be transmitted to the following aircraft, so that in all cases the following aircraft not only receives corresponding information about a change in state caused by a changed flight control command, in particular the flight path of the preceding aircraft, by measuring a sudden disturbance of an actual position compared to the ideal position in the wake turbulence region, but can also follow, in a proactive and anticipatory way, a change in the wake turbulence pattern of the preceding aircraft. The automatic response may include appropriate advance control to change the position or flight path of the following aircraft, or, as a precaution, to completely leave the wake turbulence. For this purpose, appropriate causal flight control commands, indications of such an occurrence such as an air traffic control instruction or a change in the position of landing flaps or airbrake flaps on the preceding aircraft are communicated to the following aircraft via a wireless connection, so that it can react early and adjust its own flight condition such as trajectory, speed or other parameters. The change in the course of the preceding aircraft particularly concerns a change in the course of the preceding aircraft that was previously unknown to the following aircraft. In contrast, a change in attitude describes the cause of the course change, to which the following aircraft can also react accordingly in order to better follow an expected change in the position of the wake turbulence from its originally estimated course, to be able to anticipate and adjust to the resulting curvatures in the wake turbulence course by appropriate advance control, or, as in the case of a safety-critical situation on the preceding aircraft, to abort the following flight for safety reasons and leave the wake turbulence by moving to the outside.

According to an advantageous embodiment, the method further comprises the following steps for entering the selected updraft zone:
determining the mass, flight path, and wingspan of a preceding aircraft;
determining the wind in the region of the preceding aircraft, wherein the determined wind comprises a crosswind component and/or a vertical wind component;
determining an estimate of the location of an exploitable extent of the wake turbulence based on the mass, flight path, and wingspan of the preceding aircraft and based on the determined wind;
generating, based on the location estimate, a desired trajectory for the following aircraft to enter an updraft zone of a wake turbulence of the preceding aircraft, wherein a selection is made on whether the desired trajectory enters an updraft zone of a left vortex from the left or enters an updraft zone of a right vortex of the wake turbulence from the right; and
executing the desired trajectory by the following aircraft to enter the selected updraft zone to exploit the updraft zone;

The strength of the wake turbulence can be deduced from the mass and speed of the preceding aircraft through a functional relationship or a relationship learned through machine learning; however, tabular information can also be used, for example, the existing wake turbulence categories for aircraft types such as “heavy” or “super-heavy”. This also allows for the modeling of a drift of the wake turbulence, since, as explained above, a momentum input perpendicular to the flow through the wings of the preceding aircraft was the cause of the vortices, and thus a vertical movement of the wake turbulence with both vortices as a whole downwards can be expected.

The wake turbulence is formed by such a pair of vortices and typically persists for several minutes behind a larger aircraft, such as a cargo plane or a passenger plane with at least 80 seats, which is used for transatlantic flights. Since in steady, straight horizontal flight the total aerodynamic lift must compensate for local aerodynamic down-force and the weight of the preceding aircraft, the strength of its wake turbulence and thus the formation of the individual vortices depends on its current mass. Winds can shift the wake turbulence laterally and in altitude significantly, so that in addition to the current mass of the preceding aircraft, a wind in the region of the wake turbulence is also taken into account. Based on a current and a recently passed trajectory of the preceding aircraft, a computer system can thus estimate where the wake turbulence of the preceding aircraft is currently located and is still so intense that its updraft zones can be used for the following aircraft.

Wind information can be obtained from updated databases and weather models; however, alternatively or additionally, sensor-based information can be transmitted from the preceding aircraft to the following aircraft via a communication link. This provides the following aircraft with relevant information about the exploitable extent of the region of wake turbulence. Based on this, the computer system can determine a desired trajectory that leads to a desired region of the wake turbulence. This desired region is characterized by representing an updraft zone of the wake turbulence, preferably taking into account the strength, which depends on the mass and speed of the preceding aircraft, and in particular the extent of the individual vortices, which depends on the wingspan of the preceding aircraft. It is therefore also preferable to take into account the wingspan of the preceding aircraft, as this influences the lateral and vertical extent of the wake turbulence.

The desired approach path can be followed using an autopilot and an automated flight path control system, so that the following aircraft enters an edge region of the wake turbulence from the outside. The desired flight path is calculated in such a way that it avoids crossing the wake turbulence, instead entering a left vortex from the outside from a left side or a right vortex from the outside from a right side, wherein the terms left and right can be seen both in and against the direction of flight of the preceding aircraft; the direction of view is irrelevant here. However, it is crucial that the wake turbulence is approached from the outside in order not to cross it, and in any case the downdraft region in the center of the wake turbulence is avoided.

When transitioning from the desired trajectory to the permanent residence of the following aircraft in the selected vortex, a transition can take place from an estimate to a measurement of the lateral and vertical position of the wake turbulence. While the estimate is still based on large-scale models that take into account the flight path of the preceding aircraft and the prevailing wind and other parameters, the measurement itself is empirical and provides significantly more accurate information about the current location of vortices of the wake turbulence in the region of the following aircraft compared to the estimate.

According to a further advantageous embodiment, the sensor-based detection of the airflow field in the vortex with the exploited updraft zone is carried out by a plurality of airflow sensors arranged along at least one wing.

The airflow sensors are aerodynamic and/or aerostatic sensors and are arranged along the extension direction of a wing, particularly preferably both wings, of the following aircraft. They thus cover a directional component along an aircraft transverse axis. The aircraft transverse axis extends perpendicularly to the aircraft longitudinal axis and thus along an imaginary connecting line from a wingtip of the left wing to a wingtip of the right wing. If the aircraft is a fixed-wing aircraft with swept wings, the individual airflow sensors that together form a sensor unit are still considered to be aligned and arranged along the aircraft transverse axis if they follow the sweep. Preferably, the individual airflow sensors are arranged on at least one wing of the following aircraft in such a way that their detection region is located as far as possible outside the boundary layer of the ambient air flowing around the respective wing, in particular in front of the wing, in order to be able to detect an airflow of the environment that is as unaffected and thus undisturbed as possible by the wing. The airflow sensors detect the direction and/or speed of the local airflow in front of a wing of the following aircraft. This allows the flow field of the vortex to be analyzed and, by comparison with a known formation of the same, the current position of the following aircraft relative to the vortex, whose updraft zone is currently being used by the following aircraft, to be determined in order to adjust the position for flying in an optimal updraft region. For this purpose, the airflow sensors can be designed in various ways, and differently oriented airflow sensors can also be used, which, for example, work using dynamic pressure or an angle-of-attack vane. Special designs and procedures can also be used, such as those known from the following publications:
A. Galffy, F. Car and G. Schitter, “Calibration and flight test of a 3D printed 5-hole probe for high-dynamic wind measurements for UAV,” 2019 Workshop on Research, Education and Development of Unmanned Aerial Systems (RED UAS), Cranfield, UK, 2019, pp. 362-371, doi: 10.1109/REDUAS47371.2019.8999671.
Galffy, A., Gaggl, R., Mühlbacher, R. et al. Turbulence load prediction for manned and unmanned aircraft by means of anticipating differential pressure measurements. CEAS Aeronaut J 12, 535-548 (2021). https://doi.org/10.1007/s13272-021-00512-y
A. Galffy, M. Böck, A. Kugi; Nonlinear 3D path following control of a fixed-wing aircraft based on acceleration control. Control Engineering Practice, Volume 86, 2019, Pages 56-69, ISSN 0967-0661, https://doi.org/10.1016/j.conengprac.2019.03.006.

The airflow sensors can also have different orientations in order to, for example, alternately measure a horizontal component of the surrounding airflow and a vertical component of the surrounding airflow. In such a case, successively horizontally and vertically oriented airflow sensors are arranged alternately along at least one wing, preferably along both wings, of the following aircraft, and all airflow sensors are oriented in a transverse plane perpendicular to a body-fixed longitudinal axis of the following aircraft.

According to a further advantageous embodiment, the airflow sensors for sensor-based detection of the airflow field are extended from a rest position and retracted into the rest position after leaving the airflow field. The resting position is specifically chosen so that the airflow sensors in the resting position generate no or as little additional aerodynamic drag on the following aircraft.

According to a further advantageous embodiment, the sensor-based detection of the airflow field in the vortex with the exploited updraft zone is carried out by a lidar device arranged on the following aircraft and oriented forward in the direction of a body-fixed longitudinal axis of the aircraft in a main flight direction of the following aircraft.

While typical lidar devices used in research to detect wake turbulences are positioned on the ground or directed downwards from a test aircraft, here the lidar device is used facing forwards on the following aircraft. Thus, the detection range of the lidar device is aligned along the longitudinal axis of the following aircraft, with the longitudinal axis running from the tail to the front of the aircraft and therefore pointing forward in the typical main direction of flight. The raster detection of reflections from emitted laser light signals thus essentially takes place in a rotational plane of a vortex, and the following aircraft can determine its vertical and transverse position in the rotational plane of the vortex of the wake turbulence and adjust accordingly.

According to a further advantageous embodiment, the data from the lidar device is used to determine the preceding course of the wake turbulences of the preceding aircraft and to check for curvatures due to local crosswinds and/or local vertical winds, and if a curvature is detected, the position of the following aircraft is adapted to the curvature.

While in principle a wind flow in the region of the preceding aircraft or in the region along the estimated location of the exploitable extent of the wake turbulence is detected, this basic detection can only offer a limited resolution, which may not detect very local crosswinds or local vertical winds. However, these can be indirectly taken into account by the following aircraft using the lidar device, as curvatures can be detected in the wake turbulence between the following aircraft and the preceding aircraft. For this purpose, the lidar device determines the preceding path of the wake turbulence and can detect local curvatures, i.e., lateral and/or vertical dents and bumps in the wake turbulence along its longitudinal extent, which is determined by the flight path of the preceding aircraft. Knowledge about such curvatures allows the following aircraft to counteract the effects and adjust its position along the longitudinal direction of the wake turbulence early on, so that the ideal position can be maintained as much as possible at all times and a downdraft region in the center of the wake turbulence can be avoided as much as possible by the following aircraft. Accordingly, knowledge of the future curved path of the wake turbulence generates a pre-control for the flight control system, so that when flying through such a curve, it is not necessary to react to a developing actual position of the following aircraft that deviates from the ideal position, but rather a deviation can ideally be avoided from the outset by pre-control.

According to another advantageous embodiment, the airflow field is detected using the lidar device and the airflow sensors and evaluated using two channels. The dual-channel evaluation relies on the redundancy of the information thus obtained about the airflow field of the wake turbulence located in the region of the following aircraft. This advantageously results in increased reliability during evaluation, since, for example, icing of aerodynamic sensors along a wing of the following aircraft can deliver faulty signals, while the lidar device delivers correct signals. A plausibility check can automatically determine that the signals from the aerodynamic sensors are faulty. However, even in regular operation of both sensor types, sensor fusion can mutually support information in order to increase the signal-to-noise ratio.

According to a further advantageous embodiment, the automatic reaction of the following aircraft comprises a change in a flight state of the following aircraft, in particular a change in at least one attitude angle to change the flight path of the following aircraft.

According to a further advantageous embodiment, a communication link between the preceding aircraft and the following aircraft is used to inform the following aircraft of a safety-critical situation on the preceding aircraft, so that the latter can, in particular, leave the wake turbulence.

According to a further advantageous embodiment, the wingspan of the preceding aircraft is determined, and an estimate of the width of the wake turbulence is made based on the determined wingspan.

According to another advantageous embodiment, the predefined ideal position is adjusted depending on a predetermined fraction or multiple of the span. This allows a sweet spot to be defined as an ideal position, which lies particularly laterally within a certain multiple of the wingspan of the preceding aircraft.

According to a further advantageous embodiment, the plausibility of the sensor-based detection of the airflow field is checked by an inertial measurement unit of the following aircraft.

An inertial measurement unit of an aircraft records, in particular, translational accelerations and changes in attitude angle. For example, if a wingtip of the following aircraft enters the downdraft zone of the wake turbulence of the preceding aircraft, a rolling moment can act on the following aircraft, resulting in a rolling motion which is detected by the Inertial Measurement Unit. However, a comparison of the current acceleration in the vertical direction together with the information of an aerodynamic angle of attack of the following aircraft together with an aerodynamic speed of the following aircraft can also be used for consistency checking.

Analogous to the use of an Inertial Measurement Unit, an aerodynamic angle of attack sensor of the following aircraft can also be used for a plausibility check, also in combination with data from the Inertial Measurement Unit. Such an aerodynamic angle of attack sensor is already standard equipment on passenger aircraft and serves to determine the current aerodynamic angle of attack of the entire aircraft.

According to a further advantageous embodiment, for the flight of the following aircraft in the updraft zone, fuel is pumped between a left and a right wing tank to compensate for an asymmetric lift distribution over a right and left wing of the following aircraft in the updraft zone. The asymmetrical lift distribution leads to a rolling moment, which is compensated by pumping.

According to a further advantageous embodiment, when flying into the selected updraft zone, the estimation of the location of the exploitable extent region of the wake turbulence is adjusted, wherein the entry is automatically detected by an automatic detection of the wake turbulence based on data from the sensor-based detection of the airflow field.

Another aspect of the invention relates to a system which is designed for carrying out the computer-implemented method as described above and below.

A further aspect of the invention relates to a system for automatically performing a following flight of a following aircraft in an updraft zone of a wake turbulence of a preceding aircraft, comprising:
a data interface designed to determine the mass and flight path of a preceding aircraft, and the wind in the region of the preceding aircraft, wherein the determined wind includes a crosswind component and/or a vertical wind component;
a planning module designed to determine an estimate of the location of an exploitable extent region of the wake turbulence based on the mass and flight path of the preceding aircraft and based on the determined wind, and designed to generate, based on the location estimate, a desired trajectory for the following aircraft to enter an updraft zone of a wake turbulence of the preceding aircraft, including a decision as to whether the desired trajectory enters an updraft zone of a left vortex from the left or an updraft zone of a right vortex of the wake turbulence from the right; and
a flight control system designed to automatically follow the desired flight path with the following aircraft or to assist a pilot in flying the following aircraft into the selected updraft zone for use of the updraft zone; and wherein the flight control system is designed to detect an airflow field in the vortex with the exploited updraft zone by a sensor unit arranged on the following aircraft, determine a current position of the following aircraft relative to the vortex with the exploited updraft zone based on the detected airflow field; and to adjust the current relative position of the following aircraft to assume a predefined ideal position relative to the vortex with the exploited updraft zone by controlling flight control actuators, and to execute an automatic response when at least one of the following is communicated to the following aircraft via a communication link from the leading aircraft to the following aircraft: a changed flight control command on the preceding aircraft, an air traffic control instruction for the preceding aircraft, a command to change a landing flap position or brake flap position, or any other nominal value relating to the flight path on the preceding aircraft.

The flight control system preferentially executes a basic controller, which in turn receives setpoints from higher control loops that regulate adherence to the desired flight path. Alternatively, the basic controller can be active but guided by manual flight control signals, in which case a pilot of the following aircraft is supported in manual flight control to follow the desired trajectory. Such support can be implemented, for example, by displaying the desired movement path on a head-up display of the following aircraft. In some advantageous embodiments, the data interface may be connected to a ground-based wind modeling data processing unit, or generally to a weather forecasting system, providing current wind data in the region of the preceding aircraft.

Advantages and preferred refinements of the proposed system result from an analogous and corresponding transfer of the statements made above in conjunction with the proposed computer-implemented method. In some embodiments, the system comprises a programmed computer or a processor that executes instructions stored in a non-transitory memory to perform operations of the above-described computer-implemented method.

Further advantages, features, and details will be apparent from the following description, in which optionally with reference to the drawings-at least one example embodiment is described in detail.

### BRIEF DESCRIPTION OF THE DRAWINGS

In the Drawings:

FIG. 1 shows a method according to an example embodiment of the invention,

FIG. 2 shows a scenario in which, according to an example embodiment of the invention, a following aircraft approaches the wake turbulence of a preceding aircraft.

FIG. 3 shows an example of the wake turbulence of a preceding aircraft.

FIG. 4 shows a more detailed description of a vortex of the wake turbulence of FIG. 3.

FIG. 5 shows an arrangement of airflow sensors on the following aircraft according to an example embodiment of the invention.

FIG. 6 shows a following aircraft with a lidar device according to an example embodiment of the invention.

The illustrations in the figures are schematic and not to scale.

### DETAILED DESCRIPTION

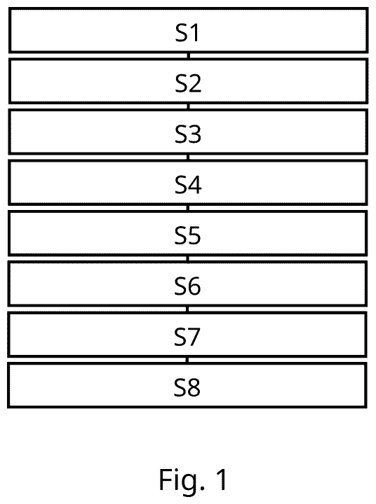

FIG. 1 shows a computer-implemented method for performing a following flight of a following aircraft 1 in an updraft zone of a wake turbulence of a preceding aircraft 2, comprising the steps:
determining S1 a mass and a flight path of a preceding aircraft 2;
determining S2 a wind in the region of the preceding aircraft 2, wherein the determined wind includes a crosswind component and/or a vertical wind component;
determining S3 an estimate of a location of an exploitable extent region of the wake turbulence based on the mass and flight path of the preceding aircraft 2 and based on the determined wind;
generating S4, based on the estimation of the location, a desired trajectory 3 for the following aircraft 1 to enter an updraft zone of a wake turbulence of the preceding aircraft 2, wherein a selection is made as to whether the desired trajectory 3 enters an updraft zone of a left vortex from the left or an updraft zone of a right vortex of the wake turbulence from the right;
executing S5 the desired trajectory 3 by the following aircraft 1 to fly into the selected updraft zone in order to exploit the updraft zone;
with the following aircraft 1 in the updraft zone: sensor-based detecting S6 an airflow field of the vortex with the exploited updraft zone;
based on the detected airflow field: determining S7 the current position of the following aircraft 1 relative to the vortex with the exploited updraft zone; and
automatically adjusting S8 the current position of the following aircraft 1 to assume a predefined ideal position relative to the vortex with the exploited updraft zone by executing a flight control system of the following aircraft 1.

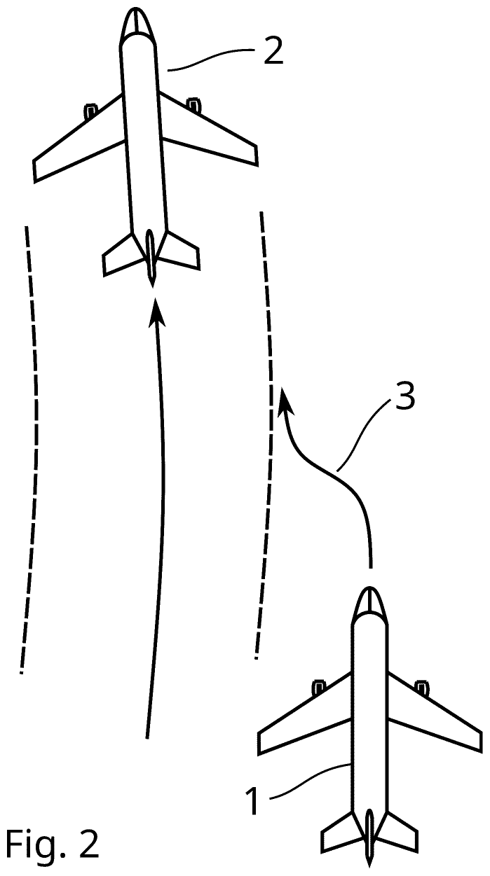

FIG. 2 shows an example situation with a preceding aircraft 2 and a following aircraft 1, for which a desired trajectory 3 is generated using the method of FIG. 1. The flight path of the preceding aircraft 2 is shown, and to the left and right of it are possible curves that mark the respective center of a left and right vortex of the wake turbulence behind the preceding aircraft 2. A strategic pre-selection of possible preceding aircraft 1 and routes that result in the longest possible common path for preceding and following aircraft 2 can usually be done days before the flight for passenger or cargo airliners, among other things by airlines registering and thus publishing their planned flights with air traffic control. The international flight planning system can be used as a data basis, either directly in the flight plan or later, e.g., via a separate equipment identifier or a separate meta-flight plan database, in which the flight plans are stored with certain limits, e.g., minimum distances to not be undercut, commitments on individual agreements, e.g., desired flight altitude, role distribution, route preference, start and end points of the method, time frame. In accordance with the pre-selection, the planned flight path for a subsequent aircraft 1 must also be selected and registered as part of the flight path. Subsequently, a tactical analysis of potential preceding aircraft 1 with suitable characteristics can be carried out by a following aircraft 1, especially after a takeoff by a potentially preceding aircraft 2. For this, online access from the air to one of the aforementioned databases may be required-this is usually quite feasible near a takeoff site over a continent, but further over the Atlantic via satellite connection. A high-rate, secure air-ground data connection like LDACS-A/G is advantageous here. As a result, a preceding aircraft 2 is selected in this function. If the preceding aircraft 2 is not yet in the air, there is a risk that its takeoff will be delayed compared to the submitted plan, meaning that the tactical selection will have to be repeated at a later time or that no following flight may take place at all. The following aircraft 1 can then be guided to the selected preceding aircraft 2 using conventional Air Traffic Control (ATC) procedures. Both strategic and tactical planning advantageously consider whether necessary detours will result in higher fuel consumption. From a certain distance (e.g., one hundred nautical miles) between the preceding aircraft 2 and the following aircraft 1, a direct communication link is established between them, i.e., not via ground stations or satellites, which is sufficiently dimensioned with regard to data rate, has the lowest possible latency and is as secure as possible in terms of information technology, i.e., is at least authenticated, and is fully established at the latest when the minimum ATC safety distances are reached (e.g., 1000 ft vertical distance and laterally up to eight nautical miles behind a preceding aircraft 2 of the wake turbulence category Super Heavy such as an Airbus model A380). Through this connection, the preceding aircraft 2 automatically communicates all significant changes to its flight path and/or the resulting control maneuvers (up/down, right/left, faster/slower) to the following aircraft 1 within defined reaction times (e.g. 100 ms), so that the latter can automatically and quickly react to the resulting change in the absolute position of the preceding aircraft 2 in space, which will also change the local position of the wake turbulences. A high-rate air-to-air data link such as LDACS-A/A is advantageous for this purpose, whereas a conventional ADSB broadcast has too high a permissible latency and too low a rate. An evaluation of position updates, such as those transmitted at a comparatively low data rate by an ADS-B transponder from the preceding aircraft 2, is not sufficient for the primary control of the following aircraft 1, but can be integrated into the overall procedure as an additional information channel for monitoring purposes. Only with the established high-rate A/A connection can the framework of normal ATC procedures be abandoned and the following aircraft 1 be flown closer to the preceding aircraft 2 in order to assume an advantageous position to exploit the updraft zones from its wake turbulences (e.g. at a distance of one nautical mile behind and slightly offset laterally). The flight path with the desired trajectory must always be chosen in such a way that the safety of the following aircraft 1 is always guaranteed, even in the event of a failure of A/A communication. This means, for example, that the following aircraft 1 approaches one of the two vortices of the wake turbulence from above and outside, and, for example, in the event of a failure of the A/A communication link, again takes a safe distance upwards and outside and to the rear. Since wake turbulences themselves have a sink rate of approximately 500 ft/min, approaching or moving away from the wake turbulence from a higher altitude can also be achieved by longitudinally approaching or moving away at the same altitude up to a certain minimum distance. To enable the following aircraft 1 to achieve the best possible self-positioning relative to the preceding aircraft 2 and to allow for automatic correction of the positioning, two measurement methods are possible, either individually or in combination: On the one hand, a lidar device can be used on the following aircraft 1 to identify the wake turbulence of the preceding aircraft 2, to locate it precisely, and to predict the position or changes in the position of the wake turbulence in advance. On the other hand, several airflow measurement sensors 4 can be attached to the wings of the following aircraft 1. These airflow measurement sensors 4 make it possible to determine the position of the greatest total lift within the wake turbulence. Both options make it possible to automatically control, maintain, and adjust the optimal position of the following aircraft 1 in relation to the wake turbulence of the preceding aircraft 2 using flight control, in order to exploit as much updraft as possible for additional aerodynamic lift on the following aircraft 1 and thus fly in the most fuel-efficient way possible. Similar to the creation of a following flight established by the following aircraft 1, the following procedure is used when breaking up the formation: The following aircraft 1 allows itself to fall back slowly in order to gain sufficient distance in the longitudinal direction from the preceding aircraft 2, if this has been coordinated with ATC beforehand regarding separation. If speed is of the essence, e.g., in an emergency involving one of the aircraft, the following aircraft 1 may also move upwards into another flight plane, preferably with a vertical distance of 305 m to the preceding aircraft, and/or veer outwards without entering an adjacent airway.

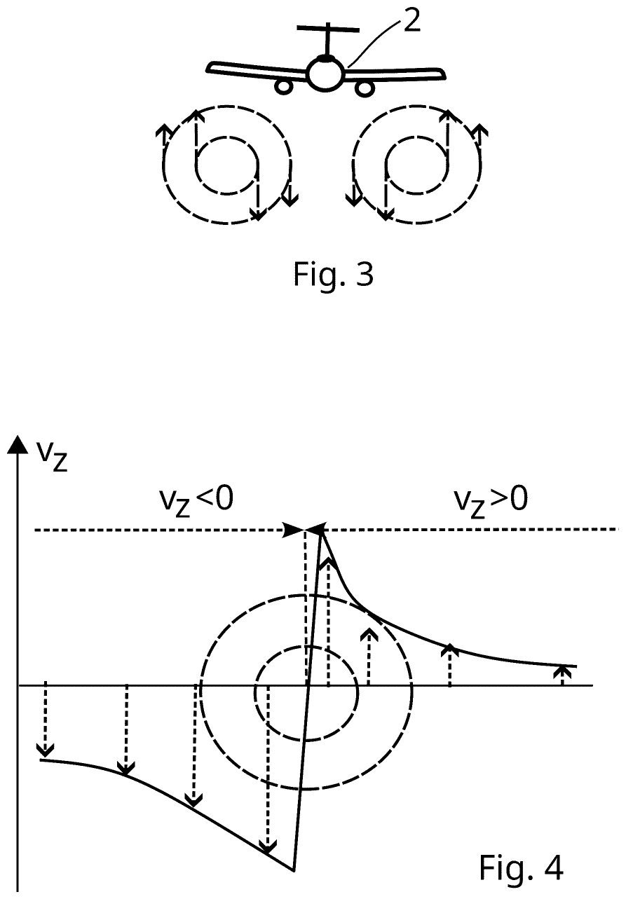

FIG. 3 shows, from the perspective of the following aircraft 1, an airflow generated by a wake turbulence from the preceding aircraft 2. While the wings of the preceding aircraft 2 generate a downdraft in the center below, this downdraft creates a left and a right vortex, each of which in turn creates an updraft zone on the outside. Firstly, one can fly into the updraft zone of the left vortex from the left, and secondly, into the updraft zone of the right vortex from the right, from the perspective of the following aircraft 1. The straight arrows in FIG. 3 illustrate the flow directions of the updraft zones and the downdraft zones behind the preceding aircraft 2.

FIG. 4 shows the vortex drawn on the right in FIG. 3 in more detail, with an additional sketch of a flow profile with vertical airflow in the direction vz along a transverse direction in the projected plane of the vortex. Outside the center of the vortex is an updraft zone that increases in strength while approaching the center. In this updraft zone, vz is positive because in this case the coordinate system for the vertical airflow is defined in such a way that updrafts receive a positive value. However, if the center of the vortex is crossed inwards, vz is negative, i.e., downdrafts prevail here, which must be avoided by the following aircraft 1. An ideal position for the following aircraft 1 is advantageously defined such that the wingtip, in this example the left wingtip, of the following aircraft 1 no longer protrudes into the downdraft region with vz<0, since beyond a certain degree of protrusion, the sum of all updraft and downdraft components along the wing entering the vortex could cause a significant rolling moment on the following aircraft 1 into the vortex. The ideal position is defined, in particular, with a corresponding safety distance for the change from vz>0 to vz<0, in order to automatically and safely maintain a predetermined lateral limit.

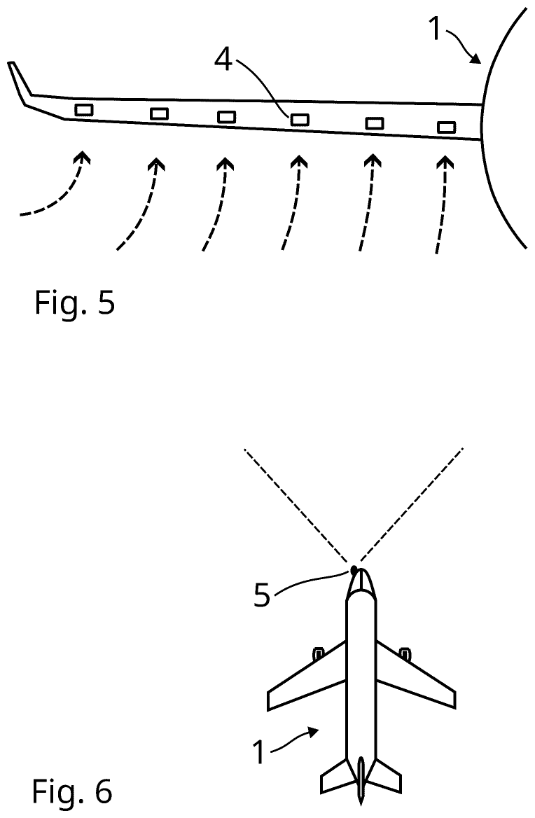

FIG. 5 shows, from the perspective of the surrounding airflow, the leading edge of a wing of a following aircraft 1. This is therefore the right wing of the following aircraft 1 from the perspective of the following aircraft 1 direction of flight. The dashed curved arrows indicate the respective path of a streamline within a vortex of a wake turbulence from a preceding aircraft 2. This shows that current filaments located on the outside of the vortex travel a larger radius than current filaments located further towards the center of the vortex. Accordingly, at the point of impact on a position on the wing with one of the many airflow sensors 4, a different direction vector results, and in general a different flow velocity. Since the airflow sensors 4, of which for simplicity only one is designated as such in FIG. 5, are arranged distributed along the length of the wing, a large number of data points are obtained along a transverse axis of the following aircraft 1 for a flow field in front of its wing, and thus approximately in the undisturbed environment of the following aircraft 1. From this data set, by comparison with information about such a vortex, whose extent and flow cross-section are known from scientific papers, the position of the following aircraft 1 relative to the vortex can be determined quite accurately, and can be controlled to an ideal position.

FIG. 6 shows a following aircraft 1 from a bird's-eye view, which, in contrast to the airflow sensors 4 of FIG. 5, has a lidar device 5. This does not, of course, preclude the possibility that a following aircraft 1 may be equipped with both airflow sensors 4 and a lidar device 5. The lidar device 5 is oriented forward in a main flight direction of the following aircraft 1 in order to be able to detect the wake turbulence with the vortices from a perspective as shown in FIG. 3 and FIG. 4 and to be able to accurately determine their vertical and lateral position relative to the following aircraft 1. Based on this data from the lidar device 5, the flight control can be executed accordingly to keep the following aircraft 1 in an ideal position relative to a selected vortex.

Although the invention has been further illustrated and described in detail by way of preferred example embodiments, the invention is not limited by the disclosed examples, and other variations can be derived therefrom by a person skilled in the art without departing from the scope of protection of the invention. It is therefore clear that a multitude of possible variations exists. It is also clear that embodiments mentioned as examples are really only examples, which are not to be construed in any way as limiting the scope of protection, the possible applications, or the configuration of the invention. Rather, the preceding description and the description of the figures enable a person skilled in the art to implement the example embodiments, wherein a person skilled in the art may make various changes knowing the disclosed inventive concept, for example with regard to the function or arrangement of individual elements cited in an example embodiment, without departing from the scope of protection as defined by the claims and their legal equivalents, such as more extensive explanations in the description.

1. A computer-implemented method for performing a following flight of a following aircraft in an updraft zone of a wake turbulence of a preceding aircraft, the method comprising:
sensor-based detecting an airflow field of a vortex with an exploited updraft zone with the following aircraft being in the updraft zone;
determining a current position of the following aircraft relative to the vortex with the exploited updraft zone based on the airflow field as detected; and
automatically adjusting the current position of the following aircraft to assume a predefined ideal position relative to the vortex with the exploited updraft zone by executing a flight control system of the following aircraft, wherein the following aircraft executes an automatic response when, via a communication link from the preceding aircraft to the following aircraft, at least one of the following is communicated to the following aircraft: a modified flight control command on the preceding aircraft, an air traffic control instruction for the preceding aircraft, or a command to change a landing flap position or air-brake flap position on the preceding aircraft.

2. The method according to claim 1, further comprising the following for flying into a selected updraft zone:
determining a mass and a flight path of the preceding aircraft;
determining a wind in a region of the preceding aircraft, wherein the wind as determined comprises a crosswind component and/or a vertical wind component;
determining an estimate of a location of an exploitable extent region of the wake turbulence based on the mass and the flight path of the preceding aircraft, and based on the wind determined in the region of the preceding aircraft;
generating, based on the estimate of the location, a desired trajectory for the following aircraft to enter the selected updraft zone of a wake turbulence of the preceding aircraft, wherein a selection is made as to whether the desired trajectory enters an updraft zone of a left vortex of the wake turbulence from a left or an updraft zone of a right vortex of the wake turbulence from a right; and
executing the desired trajectory by the following aircraft to fly into the selected updraft zone in order to exploit the updraft zone.

3. The method according to claim 1, wherein the sensor-based detecting of the airflow field in the vortex with the exploited updraft zone is carried out using a plurality of airflow sensors arranged along at least one wing of the following aircraft.

4. The method according to claim 3, wherein the method comprises:
extending airflow sensors from a rest position for the sensor-based detection of the airflow field; and
retracting the airflow sensors into the rest position after leaving the airflow field.

5. The method according to claim 1, wherein the sensor-based detection of the airflow field in the vortex with the exploited updraft zone is carried out using a lidar device arranged on the following aircraft and oriented forward in a direction of a body-fixed longitudinal axis of the aircraft in a main flight direction of the following aircraft.

6. The method according to claim 5, wherein the method further comprises:
determining a preceding course of the wake turbulence of the preceding aircraft using data from the lidar device;
checking for a curvature of the wake turbulence due to local crosswinds and/or local vertical winds; and
adapting the position of the following aircraft to the curvature if the curvature is detected.

7. The method according to claim 1, wherein automatic response of the following aircraft comprises a change in a flight state of the following aircraft.

8. The method according to claim 1, wherein the method comprises:
determining a wingspan of the preceding aircraft; and
making an estimate of a width of the wake turbulence and/or of a relative position of axes of rotation of vortices of the wake turbulence based on the wingspan as determined.

9. The method according to claim 8, wherein the method comprises adjusting the predefined ideal position depending on a predetermined fraction or multiple of the wingspan.

10. The method according to claim 1, wherein, for the following flight of the following aircraft in the updraft zone, the method comprises pumping fuel between a left wing tank and a right wing tank to compensate for an asymmetric lift distribution over a right wing and a left wing of the following aircraft in the updraft zone.

11. A system to perform a following flight of a following aircraft in an updraft zone of a wake turbulence of a preceding aircraft, the system comprising:
a processor; and
a non-transitory memory storing instructions that, when executed by the processor, cause the processor to perform operations comprising:
sensor-based detecting an airflow field of a vortex with an exploited updraft zone with the following aircraft being in the updraft zone;
determining a current position of the following aircraft relative to the vortex with the exploited updraft zone based on the airflow field as detected; and
automatically adjusting the current position of the following aircraft to assume a predefined ideal position relative to the vortex with the exploited updraft zone by executing a flight control system of the following aircraft, wherein the following aircraft executes an automatic response when, via a communication link from the preceding aircraft to the following aircraft, at least one of the following is communicated to the following aircraft: a modified flight control command on the preceding aircraft, an air traffic control instruction for the preceding aircraft, or a command to change a landing flap position or air-brake flap position on the preceding aircraft.

12. The system according to claim 11, wherein the operations for flying into a selected updraft zone comprise:
determining a mass and a flight path of the preceding aircraft;
determining a wind in a region of the preceding aircraft, wherein the wind as determined comprises a crosswind component and/or a vertical wind component;
determining an estimate of a location of an exploitable extent region of the wake turbulence based on the mass and the flight path of the preceding aircraft, and based on the wind determined in the region of the preceding aircraft;
generating, based on the estimate of the location, a desired trajectory for the following aircraft to enter the selected updraft zone of a wake turbulence of the preceding aircraft, wherein a selection is made as to whether the desired trajectory enters an updraft zone of a left vortex of the wake turbulence from a left or an updraft zone of a right vortex of the wake turbulence from a right; and
executing the desired trajectory by the following aircraft to fly into the selected updraft zone in order to exploit the updraft zone.

13. The system according to claim 11, wherein the sensor-based detecting of the airflow field in the vortex with the exploited updraft zone is carried out using a plurality of airflow sensors arranged along at least one wing of the following aircraft.

14. The system according to claim 13, wherein the operations comprise:
extending airflow sensors from a rest position for the sensor-based detection of the airflow field; and
retracting the airflow sensors into the rest position after leaving the airflow field.

15. The system according to claim 11, wherein the sensor-based detection of the airflow field in the vortex with the exploited updraft zone is carried out using a lidar device arranged on the following aircraft and oriented forward in a direction of a body-fixed longitudinal axis of the aircraft in a main flight direction of the following aircraft.

16. The system according to claim 15, wherein the operations further comprise:
determining a preceding course of the wake turbulence of the preceding aircraft using data from the lidar device;
checking for a curvature of the wake turbulence due to local crosswinds and/or local vertical winds; and
adapting the position of the following aircraft to the curvature if the curvature is detected.

17. The system according to claim 11, wherein automatic response of the following aircraft comprises a change in a flight state of the following aircraft.

18. The system according to claim 11, wherein the operations comprise:
determining a wingspan of the preceding aircraft; and
making an estimate of a width of the wake turbulence and/or of a relative position of axes of rotation of vortices of the wake turbulence based on the wingspan as determined.

19. The system according to claim 18, wherein the operations comprise adjusting the predefined ideal position depending on a predetermined fraction or multiple of the wingspan.

20. The system according to claim 11, wherein, for the following flight of the following aircraft in the updraft zone, the operations comprise pumping fuel between a left wing tank and a right wing tank to compensate for an asymmetric lift distribution over a right wing and a left wing of the following aircraft in the updraft zone.
